(19) United States
(12) Patent Application Publication
(10) Pub. No.: US 2010/0166965 A1
(43) Pub. Date: Jul. 1, 2010

(54) SEAL WITH SUPPORT AND PRODUCTION OF SAME

(76) Inventors: Ralf Salameh, Gondelsheim (DE); Timo Walz, Gondelsheim (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/721,680

(22) Filed: Mar. 11, 2010

Related U.S. Application Data
(62) Division of application No. 11/181,141, filed on Jul. 14, 2005.

(30) Foreign Application Priority Data
Jul. 15, 2004 (DE) 10 2004 034 236.9

(51) Int. Cl. B05D 3/12; B05D 1/02; B05D 3/00

(52) U.S. Cl. 427/299; 427/427.1; 427/372.2; 427/355

(57) ABSTRACT

The seal comprises a two-dimensional support, to which on one-side or both-sides an elastomer is applied by means of an injection molding process. The elastomer of the seal consists of at least one elastomer material. For the manufacture, a support is provided which is continuously fed to a pick apparatus, which cyclically applies on one or both sides an organic elastomer material as seal to the support. Subsequently, the seal is punched free.

This application is a divisional application which claims priority to German Patent Application No. 10 2004 034 236.9, filed Jul. 15, 2004, and U.S. patent application Ser. No. 11/181,141, filed Jul. 14, 2005.

### BACKGROUND OF THE INVENTION

1. Technical Field

The present invention relates to seals made out of organic elastomer materials.

2. Related Art

Previously known seals are made from metallic support frameworks and, as the case may be, supports of most different variations, which are adaptable with diversity to specific applications, and which can exhibit a multitude of variations in the configuration of the metallic support frame. In the field of sheet metal supports, previous manufacturing processes are in operation, by means of which metal sheets of aluminum or steel as carrier were introduced onto elastomer substrates, for example, by spraying or stamping. With methods with which materials such as, for example, silicone are applied by a robot with volumetrically metering, and afterwards a tool stamping operation takes place, various seal geometries can be actualized.

An advantage of this known and conventionally used process is that the production can take place in a continuous process, which begins with the unwinding of the support strips on a spool or so-called coil, and ends with the product seal, which is introduced onto a support frame. However, a critical disadvantage of this process is that only very few of the known and conventionally used elastomer materials which ordinarily are used in rubber-injection molding processes can be utilized in this aforementioned briefly described conventional process. These elastomeric materials require specific process parameters (such as pressure and temperature) which are only obtained in the ordinary rubber-injection molding processes. Moreover, some elastomer materials are suitable to substantially cover the overall requirements in respect to material properties such as, for example, temperature and media resistance which are to be fulfilled under specific application conditions.

In order for seals to be manufactured in the conventional elastomer-injection molding process, individual carrier frames are inserted by hand or machine in an injection device, so that the carrier joined with the elastomer can be extrusion coated or the elastomeric seal is injectable at the frame edges. With this elastomer-injection molding process, the parts subsequently pass through various process steps, which are not connectable in the sense of a continuous process. The inserts, usually of metal, are punched beforehand in separate process steps. Several frame parts are partially punch connected with smaller parts and are subsequently further separated after the run-through of all manufacturing steps. Seals are further separated after the run-through of all manufacturing steps. In order for seals of elastomeric material upon carrier thin metal sheets to be constructed, some thin metal carrier sheets are coated by spraying, or the thin metal sheets are passed through so-called “coating curtains”. Seals which are produced in processes in which, for example, sealing material is applied with the aid of a robot, and with particular types of seal, a sealing geometry or, respectively, a sealing contour is impressed by means of a stamping tool.

Also, seals made from conventional sealing materials are pure rubber-form seals or seals with aluminum or steel carrier frames, with which the seal geometry is injection molded, or the carrier frame is completely extrusion-coated. Alternative seals, whose construction is based upon thin metal sheets, are limited to specific production methods. Since these take place substantially by spray or “curtain coating” processes, only very thin sheets are realizable. These seals are generally welted for the production of higher linear pressing. The superimposition of sealing lips is not possible. Seals in which sealing lips are introduced upon thin metal sheets are typically based upon the inorganic elastomer material silicone.

### SUMMARY OF THE INVENTION AND ADVANTAGES

It is the object of the present invention to provide a seal and a process for its manufacture, which is producible in a continuous process with use of organic elastomer materials as sealing materials, whereby the seal materials used possess properties, which usually allow use only by means of injection molding.

In accordance with the invention, a seal for the bordering of a medium is provided. The seal comprises a flat carrier having an elastomer on one or both sides of same which is introduced by means of an injection molding process. The elastomer of the seal is formed from at least one organic elastomer material.

Advantageously, the organic elastomer material is fluorinated rubber (FPM), acrylate-rubber, polyacrylate-acrylic resin, polyacrylate (ACM), ethylene acrylate (AEM), ethylene-propylene (EPDM), and/or hydrogenated nitrile (HNBR). Preferably, the organic elastomeric materials exhibit a substantial portion of volatile matter of about 0.1% and less, which can be measured by means of thermogravimetric analysis (TGA) at 150° C. over 0.5 hour. In particular, the organic elastomer material exhibits a Mooney-viscosity ML (1+4) at 100° C. in a range from about 20 to 100, particularly in a range from around 25 to 52. Preferably the seal comprises a range of different organic elastomer materials. According to the invention, the support can be prepared from a support material comprising metals, plastics, and/or paper-like materials.

Advantageously, the seal exhibits fixing areas for the orientation of the seal during the injection molding process. The fixing areas during this process particularly consist of one or more fixing points and/or longitudinal fixing areas, upon which a pick tool can effect guiding and/or aligning.

Preferably the seal possesses flat sealing areas and/or sealing areas with one or more seal lips. In particular, a substantially variable seal geometry is realizable by means of the injection molding process.

More advantageously, the seal has a minimum of one spacing element in the form of an area-wise folded or embossed support.

According to the invention, a method for the manufacture of a seal in a continuous process is provided. A support is furnished for the seal. The support is continuously fed to a pick apparatus, which, in an injection molding process, applies cyclically an organic elastomer material on one side or both sides to the support. Subsequently, the seal is punched free.

Advantageously, the pick apparatus comprises a tapering tool, with whose aid substantially any seal geometry can be realized.

Preferably, in the injection molding process the organic elastomer materials are extrude-injected or injection-molded. The injected elastomer material is carried by the support while the injected elastomer material couples to the support and substantially extends itself in or on the unsupported area.

Advantageously, the process also comprises a drying and/or annealing operation of the organic elastomer material for a predetermined drying or annealing time period. Additionally, the process can likewise include a die-cutting operation of the support before the introduction of the organic elastomer material. Furthermore, the process can similarly provide for a stamping and/or punching operation of the seal.

### THE DRAWINGS

The invention is explained in more detail by means of a specific embodiment of the invention using the following drawings as exemplary, in which:

FIG. 1 is a perspective view of a seal according to a specific embodiment of the invention; and

FIGS. 2a to 2f are perspective schematic views of further specific embodiments of the invention.

### DETAILED DESCRIPTION

In the figures as well as in the description the same reference numerals are used, in order to designate the same or similar component parts or elements.

In accordance with the invention, a solution is proposed as follows which fulfills the goal and provides a process, which makes possible a continuous manufacturing process by use of organic sealing-materials. The support material (metal, paper, plastic) is fed from a coil or a roll. In an optional pretreatment step the material can pass through planned coating levels in the event this is necessary. If certain pre-punching or stamping operations are required, a punch or stamp-press or combination can pre-punch and/or stamp the areas the roll runs through. Then the roll is led through an elastomer-injection molding machine which cyclically extrudes or injects the seal on one or both sides.

According to the invention no conventional inorganic elastomers such as, for example, silicone are used, but rather a multiplicity of organic elastomers such as fluorinated rubber (FPM), acrylate-rubber, polyacrylate-acrylic resin, polyacrylate (ACM), ethylene acrylate (AEM), ethylene-propylene (EPDM), and/or hydrogenated nitrile (HNBR) and the like. These organic elastomers, which are utilized in the elastomer injection molding process, typically exhibit a Mooney-viscosity ML (1+4) at 100° C. in a range from about 20 to 100. The exact Mooney-viscosity is dependent on the raw material choice and the Shore A hardness of the material. For use with cross-spraying of support materials in the injection molding process, the Mooney-viscosity ML (1+4) at 100° C. should lie in the range from about 25 to 52.

The seals of the invention are especially suitable for applications in which the portion of volatile material which can escape from the seal may not exceed a predetermined small amount. Some requirements, for instance, are set for seals in fuel cells, the operation and function of which can be impaired by the volatile materials leaking from the seals. With conventional seals which are constructed on the basis of well-established elastomer materials, the portion of volatile materials which is measured by means of thermogravimetric analysis (TGA) at 150° C. over 0.5 hours is approximately 1% or less. The portion of volatile materials of the seals of the invention is of minor significance, so that these are suitable for applications which the requirements as explained above are set in respect to a lowest possible portion of volatile material.

After the run-through of the injection molding machine, the reel can pass the material vulcanized through an annealing route. Otherwise, also only on the part with injected seal can stamp or punch operations still be disposed downstream. The parts are subsequently punched free and are completed finished pending a possible concluding test and/or visual inspection. In case longer annealing times are necessary, the completed parts can only be fed directly to a continuous annealing process and are then completed.

This process according to the invention and the new types of seal produced thereby combine the advantages of a seal prepared in a continuous process (low handling expenses, minor material commitment, cost-effective manufacture) with the use of a large material diversity of organic elastomers at the higher temperature range and with improved stability. With the aid of the proposed injection molding process it is also possible to apply various seal-materials in different sealing areas.

In one embodiment of the invention, this seal is based upon a support whose support materials, for example, comprise metal, plastic, paper, paper-like materials and the like, from which a seal geometry is molded on one or both sides. With special variants, component areas of the seal extrusion-injected areas convert into injection molded areas which are no longer supported by the support. A thin organic elastomer layer is injection molded upon the support in the sealing areas. On this, preferably two seal lips are arranged. Alternatively, the seal contour or seal geometry can also be designed with one or more seal lips. Furthermore, component areas are also possible, in which no seal lip is arranged. On the seal there are places in the injection molded areas by which the support is held in the tool in the middle position and thereby the support is held in the center between the two elastomer layers and the seal lips. The seal can possess sealing areas made from various organic elastomer materials in order to utilize an optimally adjusted material for each medium or, as the case may be, each application situation. A special form of the seal has a so-called separator or limiter, which limits the grouting of the seal. These can be manufactured by recasting from the support material or they are integrated by additional elements.

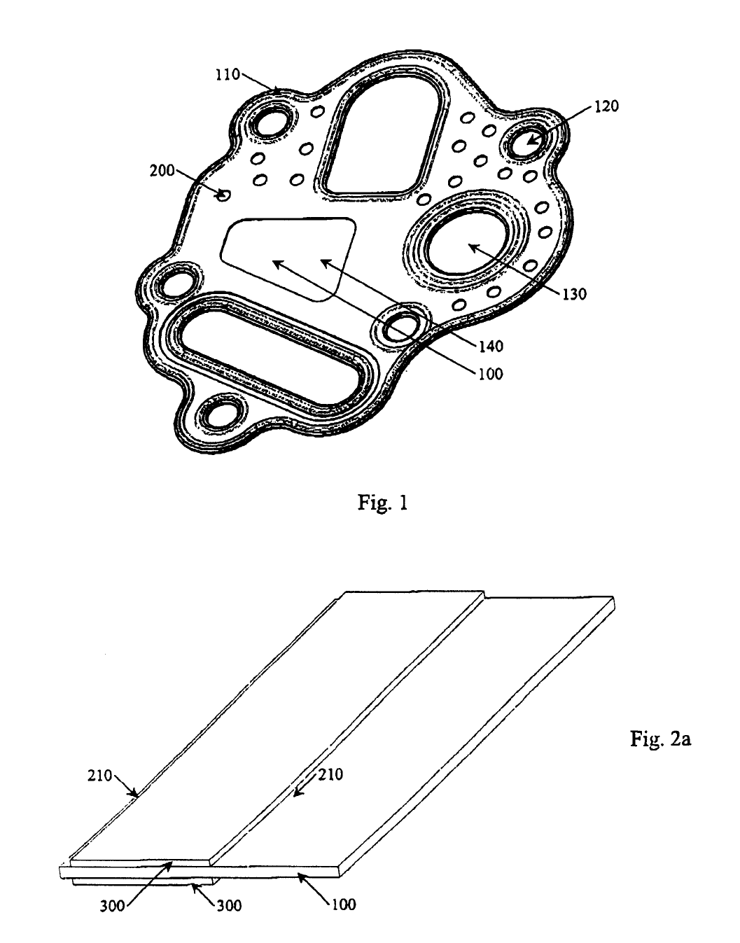

FIG. 1 shows a seal according to an embodiment of the invention. The seal illustrated in FIG. 1 is deposited upon a support or respective support plate 100. The seal further exhibits exemplary and application-contingent seal lip 110, sealed-up mounting ports 120 and sealed-up ports 120. Optionally, the seal is provided with a seal-free area 130. Contingent upon the manufacturing process described above, the illustrated seal displays fixing point 200, to which, respectively, the manufacturing tool can impinge upon.

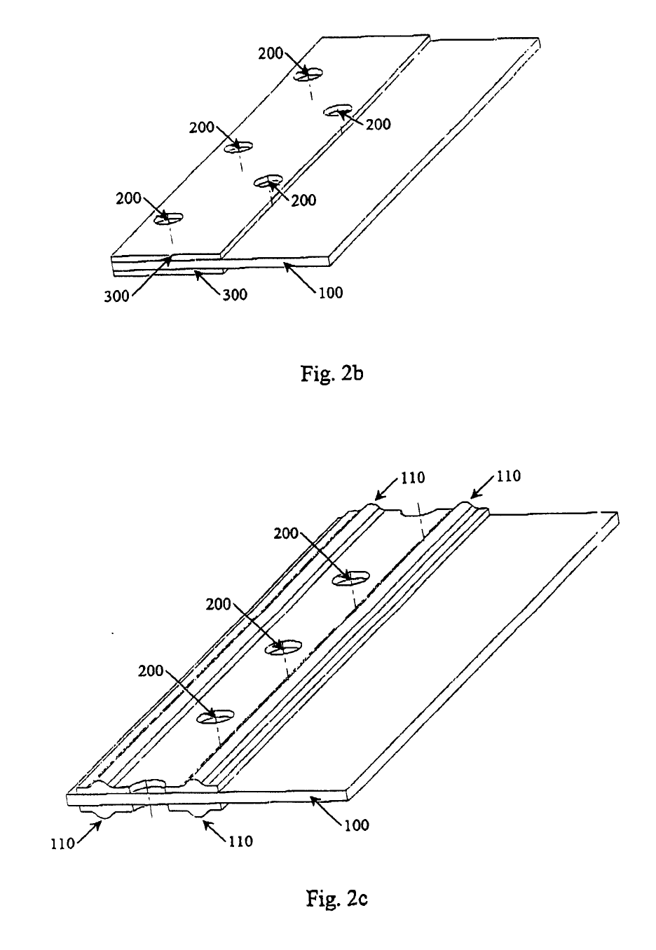

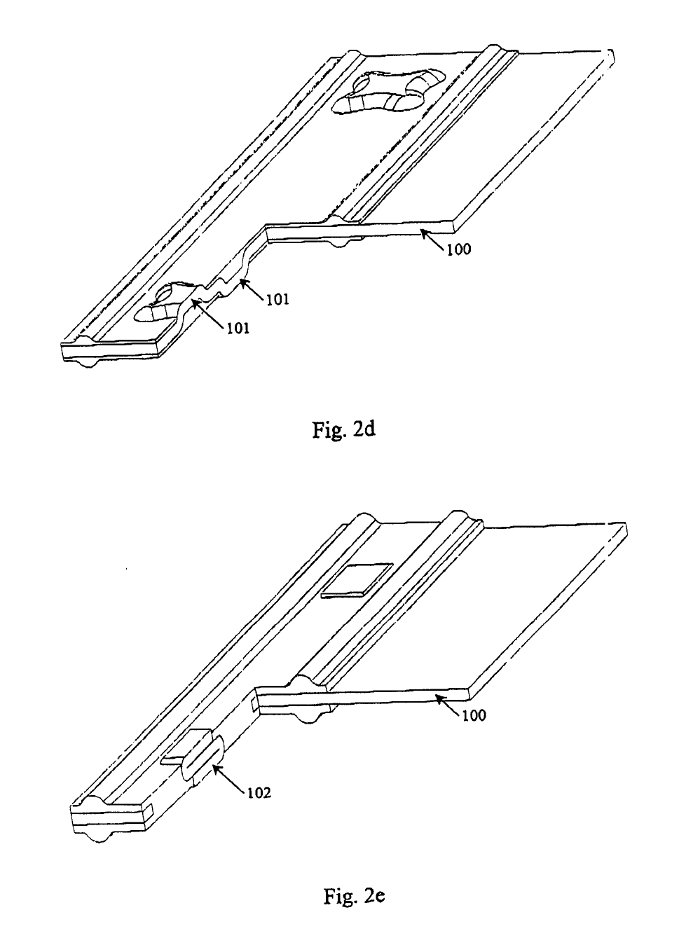

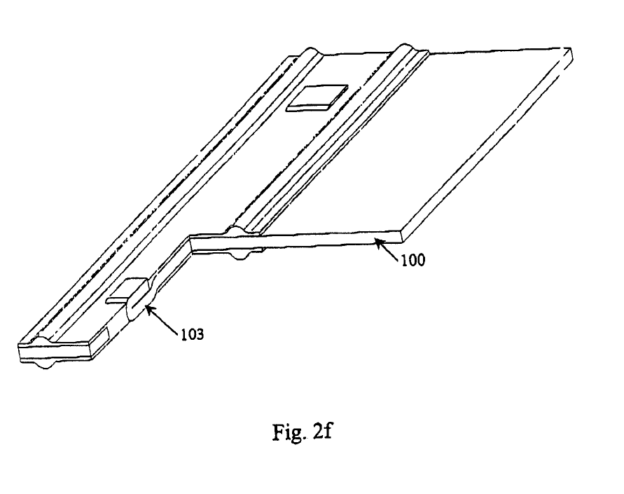

FIG. 2a up to 2f schematically show seal embodiments of the invention. The schematic representations show modifications of the seals in accordance with the invention.

In FIG. 2a is shown a first basic variant two-dimensional or, respectively, a two-dimensional in a sub-area elastomer seal, which is applied to a support 100 by means of the above-described injection molding process. Exemplary are sealing areas 300 applied on both sides to the support 100. As an alternative to the fixing point 200 shown in FIG. 1, the seal shown here is fixed in the area 210, that is, lateral to the shown two-dimensional seal surface 300 running areas, to which, respectively the tool impinges for fixation.

In FIG. 2b is shown a further variant of a two-dimensional or, respectively, a two-dimensional in a sub-area organic elastomer seal, which is applied upon a support 100 by means of the above-described injection molding process. This variant features, instead of the above-described lateral running fixing areas, a multiplicity of fixing points 200, in which, respectively, the tool impinges for fixation during the manufacturing process.

FIG. 2c illustrates second basic variants of a two-sided seal, with which a lip geometry is provided. The embodiment of the seal here shown possesses two seal lips 110 on each side of the support 100, so that as a result a double lip is obtained. Herewith, the fixation also results by means of fixing points 200. A combination of the first and second variants is possible.

FIGS. 2d to 2f show possible variations of separator or limiter, which can be used in seals in accordance with the invention. The variations of the separator are displayed by reference to the embodiments illustrated in FIG. 2c, but can also be used in combination with the first variant according to FIG. 2a or, respectively, in another connection containing mixed variants of first and second variants. In FIG. 2d a separator is first of all realized by means of a stamped support. A stamping of this kind can result by embossing of channels, especially half-channels, in the support. Furthermore, in FIG. 2e a separator is realized by means of a folded-on-both-sides area of the support, so that a separator with a height equal to the multiple folding plus one support thickness is obtained. In conclusion, in FIG. 2f a separator is realized by means of a one-sided support folding in a predetermined support area. The separator is averaged, that is, the separator is arranged concentric to the central plane of the support.

The above-described process makes possible the manufacture of cost-effective seals on the basis of organic elastomer materials as seal-materials. The process enables the introduction of thin, two-dimensional sealing areas as well as a sealing geometry or sealing contour with one or more seal lips, particularly double-lips. The lips permit preferentially larger tolerances to balance, so that a desired sealing effect can be secured. As support materials a multiplicity of different materials are suitable, such as, for example, metals or metal sheet plastics such as plastic plates, paper or paper-like plates. The proposed injection molding or on-molding to supports contributes substantially to the cost-effective completion. Organic elastomer materials which permit preparation by extrusion—or injection molding are readily available in great variety. Moreover, the tool to be used in the injection process permits a substantial creative freedom in the seal geometry. A creative freedom of this kind is not given with conventional methods. The seal of the invention is not limited to one material. A large number of different sealing materials can be combined in various sub-areas, whereby the sealing materials also are extrusion—or injection molded on the support.

1. Method for the manufacture of a gasket in a continuous process, comprising:
provision of a substrate;
continuous feeding of the substrate to a spraying device;
provision of at least one organic elastomer material;
cyclic unilateral or bilateral application of at least one organic elastomer material onto the substrate as a gasket by means of spray-application, whereby on application of the at lest one organic elastomer material onto the substrate, different organic elastomer materials are applied in certain areas to form the gasket;
alignment of the gasket by means of fixing region during spray-application, whereby the fixing regions comprise one or a plurality of fixing points and/or elongated fixing regions, on which a tool engages in a guiding and/or aligning manner; and
stamping free of the gasket.

2. Method according to claim 1, further comprising:
spraying onto of the at least one organic elastomer material that is likewise sprayed onto,
whereby the elastomer material spray-applied is borne supportively by the substrate and whereby the elastomer material sprayed onto is joined to the substrate and extends substantially into regions free from substrate.

3. Method according to claim 2, comprising:
drying and/or tempering of the organic elastomer material for vulcanization of said organic elastomer material.

4. Method according to claim 2, comprising:
pre-stamping of the substrate prior to application of the organic elastomer material.

5. Method according to claim 1, comprising: embossing and/or stamping of the gasket.

6. Method according to claim 1, comprising:
embossing and/or folding of the gasket for forming a spacer element in the shape of the substrate folded in certain areas or of the substrate embossed in certain areas in order to limit a compression of the gasket.

7. Method according to claim 1, whereby:
the gasket is aligned by means of fixing regions, the fixing regions comprising one or a plurality of fixing points and/or elongated fixing regions, on which the tool for spray application engages in a guiding and/or aligning manner.

8. Method according to claim 1, comprising:
provision of the at least one organic elastomer material with a proportion of volatile constituents, measured by means of thermogravimetric analysis over 0.5 hours at 150° C., of substantially approximately 0.1% and less, whereby the gasket is used in fuel cells.

9. Method according to claim 1, whereby the gasket has two-dimensional sealing regions and sealing regions with one or a plurality of sealing lips, which are formed by means of spray-application using a tool.

10. Method according to claim 1, whereby a material of fluorocarbon rubber (FPM), acrylate rubber, polyacrylate acrylic resin, polyacrylate (ACM), ethylene acrylic elastomer (AEM), ethylene propylene diene monomer (EPDM) and/or hydrogenated nitrile butadiene rubber (HNBR) is provided as the organic elastomer material.

11. Method according to claim 1, whereby the at least one organic elastomer material is provided with a Mooney viscosity ML (1+4) at 100° C. in the range between 20 and 100.

12. Method according to claim 1, whereby the at least one organic elastomer material is provided with a Mooney viscosity ML (1+4) at 100° C. in the range between 25 and 52.

13. Method according to claim 1, whereby the at least one organic elastomer material provided has substantially a proportion of volatile constituents, measured by means of thermogravimetric analysis over 0.5 hours at 150° C., of approximately 0.1% and less such that the gasket is suitable for use in fuel cells.
